(19) United States
(12) Patent Application Publication
(10) Pub. No.: US 2025/0214573 A1
(43) Pub. Date: Jul. 3, 2025

(54) VEHICLE SYSTEM AND NON-TRANSITORY STORAGE MEDIUM

(71) Applicant: TOYOTA JIDOSHA KABUSHIKI KAISHA, Aichi-ken (JP)

(72) Inventors: Kuniaki GOTO, Susono-shi (JP); Masumi TERAYAMA, Fuji-shi (JP); Masaki MATSUNAGA, Odawara-shi (JP); Motoki NISHIMURA, Shizuoka-ken (JP); Shigeyuki KIDO, Shinjuku-ku (JP); Shodai HORIMA, Mishima-shi (JP)

(21) Appl. No.: 19/000,703

(22) Filed: Dec. 24, 2024

(30) Foreign Application Priority Data
Dec. 28, 2023 (JP) 2023-223654

(51) Int. Cl. B60W 30/09; B60W 10/20; B60W 30/095; B60W 30/14; B60W 50/00; B60W 50/14

(52) U.S. Cl. CPC B60W 30/09; B60W 10/20; B60W 30/0956; B60W 30/146; B60W 50/0097; B60W 50/14; B60W 2554/4041; B60W 2556/45

(57) ABSTRACT

A vehicle system comprising a server device communicably connected to a vehicle, the server device includes a processor for performing an operation related to the travel of the vehicle, wherein the processor is configured to perform the following processing, calculating a traveling state including a future positional relationship between an object and the vehicle based on detection values of the object and traveling information which relates to traveling of the vehicle, wherein the object exists around the vehicle and relates to traveling of the vehicle, based on the traveling state, determining a contact risk which occurs to the vehicle in the future with the object, if the contact risk exceeds a predetermined criterion, executing driving assistance to the vehicle.

### FIELD

The present invention relates to a vehicle system and a non-transitory storage medium for reducing a risk during traveling of a vehicle.

### BACKGROUND

Patent Literature 1 (Japanese Patent Publication 2023-108224) discloses a vehicle system that reduces the contact risk between a vehicle and an object.

According to the vehicle system described in Patent Literature 1, the occupant protection device is operated, or avoidance control is executed in case of the contact risk between the vehicle and the object is equal to or greater than a predetermined value based on the monitoring result of the surroundings of the vehicle.

### SUMMARY

According to the vehicle system described in Patent Document 1, since the contact risk between the vehicle and the object is determined based on the monitoring result of the surroundings of the vehicle, in case of the contact risk is extremely high, in case of the occupant protection device is operated, there is a possibility that a burden is imposed on the occupant.

An object of the present invention is to provide a vehicle system and a non-transitory storage medium capable of speeding up calculation of a determination result of the contact risk between a vehicle and an object.

### Means for Solving the Problem

One aspect of the present invention is a vehicle system comprising a server device communicably connected to a vehicle, the server device includes a processor for performing an operation related to the travel of the vehicle, wherein the processor is configured to perform the following processing, calculating a traveling state including a future positional relationship between an object and the vehicle based on detection values of the object and traveling information which relates to traveling of the vehicle, wherein the object exists around the vehicle and relates to traveling of the vehicle, based on the traveling state, determining a contact risk which occurs to the vehicle in the future with the object, if the contact risk exceeds a predetermined criterion, executing driving assistance to the vehicle.

According to the present invention, it is possible to accelerate the calculation of the determination result of the contact risk between the vehicle and the object.

### BRIEF DESCRIPTION OF DRAWINGS

FIG. 1 is a diagram illustrating a configuration of a vehicle system according to an embodiment of the present invention.

FIG. 2 is a diagram illustrating a future traveling state of a vehicle and an object.

FIG. 3 is a sequence diagram illustrating a flow of processing of the vehicle control method executed in the vehicle system.

### DESCRIPTION OF EMBODIMENT

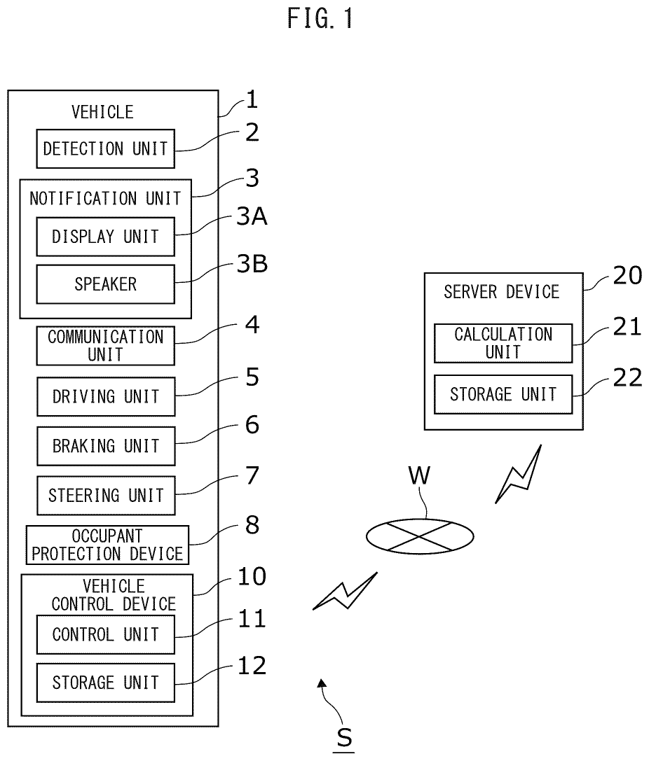

As illustrated in FIG. 1, the vehicle system S includes a vehicle 1 and a server device 20 communicably connected to the vehicle 1. The server device 20 executes an operation related to the travel of the vehicle 1 based on the data acquired from the vehicle 1 and transmits the operation result to the vehicle 1. The vehicle 1 starts a process related to occupant protection and starts a process related to driving assistance based on the calculation result.

The vehicle 1 includes a communication unit 4 connected to the network W and communicates with the server device 20 via the communication unit 4. The communication unit 4 is, for example, a wireless communication interface. The vehicle 1 includes a detection unit 2 including various sensors. The detection unit 2 acquires a detection value related to the travel of the vehicle 1. The detection unit 2 includes, for example, a camera device that captures images of an environment around the vehicle 1. The camera device includes one or more camera sensors and acquires captured images obtained by capturing the environment around the vehicle 1. The captured image includes a moving image and a still image. The captured images are stored in a 30 storage unit 12 which will be described later. The data of the captured images may be periodically updated.

A LiDAR (Light Detection And Ranging) device for detecting an object present around the vehicle 1 is provided. The LiDAR device acquires detection values regarding a relative distance, a relative position, and a shape to an object existing around the vehicle 1 by transmitting and receiving a laser wave. The detection values are stored in the storage unit 12. The detection unit 2 includes a radar device that detects the object existing around the vehicle 1. The radar apparatus acquires a detection value regarding a relative distance and a relative position to an object existing around the vehicle 1 by transmitting and receiving a radar wave. The detection values are stored in the storage unit 12.

The detection unit 2 includes an acceleration sensor that detects an acceleration generated in the vehicle 1. The acceleration sensor detects, for example, detection values in six-axis directions of accelerations occurring in the front-rear direction, the left-right direction, and the up-down direction of the vehicle 1 and angular accelerations occurring in rotation directions of a roll angle, a pitch angle, and a yaw angle of the vehicle 1. The detection values are stored in the storage unit 12. The detection unit 2 includes a position sensor that detects a current position of the vehicle 1.

The position sensor includes, for example, a sensor such as a GPS (Global Positioning System). The position sensor may be configured in combination with the acceleration sensor to calculate an inertial travel trajectory of the vehicle 1 and to complement the position of the vehicle 1 at a location where GPS cannot be received. The detection unit 2 may communicate with another vehicle via the communication unit 4 and may acquire detection values such as a relative position between the vehicle 1 and the other vehicle, a relative approach speed of the other vehicle with respect to the vehicle 1, and the like. Among the detection values, travel information related to travel of the vehicle 1, such as position information of the vehicle 1 and acceleration, are stored in the storage unit 12.

The vehicle 1 includes a notification unit 3 that outputs a notification content to be notified to the occupant. The notification unit 3 includes, for example, a display unit 3A that outputs display images generated based on characters and images. The display unit 3A includes a display device such as a liquid crystal display or an organic EL (Electro-Luminescence display. The display unit 3A may be configured by a touch panel or may be configured as an input unit that receives an operation related to the vehicle 1 based on a touch operation by an occupant. The notification unit 3 includes a speaker 3B for outputting sound. The speaker 3B is configured to output audio data related to the traveling of the vehicle 1 to the occupant.

The vehicle 1 is provided with an occupant protection device 8 for protecting the occupant. The occupant protection device 8 is constituted by, for example, an airbag device that prevents the occupant from encountering the inside of the vehicle 1. In case of the acceleration generated in the vehicle 1 is equal to or higher than a predetermined value, the airbag device protects the body of the occupant by inflating the bag body. The occupant protection device 8 is constituted by, for example, a pretensioner device that controls the tension state of the seat belt. In case of the acceleration generated in the vehicle 1 is equal to or greater than a predetermined value, the pretensioner device instantaneously increases the degree of tension of the seat belt, increases the degree of restraint of the occupant with respect to the seat, and protects the occupant.

The vehicle 1 includes a driving assistance device that supports driving of an occupant. The driving assistance device includes a traveling device related to traveling of the vehicle 1 and a vehicle control device 10 that executes control related to traveling of the vehicle 1. The traveling device includes, for example, a driving unit 5 serving as a power source for traveling of the vehicle 1. The driving unit 5 is constituted by a power source such as an internal combustion engine or an electric motor. The traveling device includes a braking unit 6 that decelerates or stops the vehicle 1. The braking unit 6 is constituted by a braking device. If the vehicle 1 is an electric vehicle, the braking device may be constituted by an electric motor constituting the driving unit 5. The traveling device includes a steering unit 7 that controls the direction of the vehicle 1. The steering unit 7 includes a steering device. If the vehicle 1 is an electric vehicle, the steering unit 7 may be constituted by an electric motor constituting the driving unit 5.

The vehicle control device 10 operates the occupant protection device 8 and the driving assistance device based on the detection values detected by the detection unit 2. The vehicle control device 10 may configure the navigation device by controlling the notification unit 3 based on the detection values detected by the detection unit 2. If functioning as a navigation device, the vehicle control device 10 calculates a travel plan including a travel route to a destination of the vehicle 1 based on an input manipulation of the user and causes the display unit 3A to display the travel plan.

The vehicle control device 10 includes, for example, a control unit 11 that executes control related to traveling of the vehicle 1 and executes control related to occupant protection, and a storage unit 12 that stores data and programs related to control. The control unit 11 is constituted by a hardware processor such as at least one CPU (Central Processing Unit). The storage unit 12 includes a non-transitory storage medium such as a hard disk drive (HDD) or a solid-state disk (SSD).

The control unit 11 determines the contact risk between the vehicle 1 and the object based on the detection value detected by the detection unit 2 and the travel information. The control unit 11 operates the occupant protection device 8 and the driving assistance device in case of the contact risk between the vehicle 1 and the object exceeds a criterion. The control unit 11 transmits the detection value detected by the detection unit 2 to the server device 20 at a predetermined timing.

In the server device 20, a calculation unit 21 acquires the detection values, the travel information, and the travel plans via the network W. The calculation unit 21 acquires information such as position information, speed, route information to the destination of the vehicle 1, information on a lane on which the vehicle 1 is traveling, and information on the object. The calculation unit 21 acquires detailed map data of the road on which the vehicle 1 is traveling from the storage unit 22 based on the detection value.

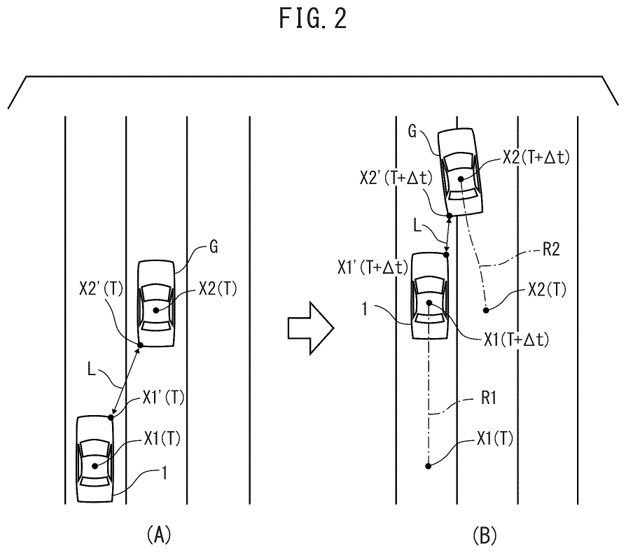

As illustrated in FIG. 2, the calculation unit 21 calculates a traveling state including a current positional relationship between the object G and the vehicle 1 in a road environment in which the vehicle 1 is traveling, based on a detection value of the object G that exists around the vehicle 1 and is related to the traveling of the vehicle and position information of the vehicle 1. The calculation unit 21 calculates not only the current traveling state of the vehicle 1 (refer to FIG. 2A) but also a future traveling state of the vehicle 1 (see FIG. 2B). The calculation unit 21 may be configured to calculate the traveling state of the vehicle 1 in the future by repeatedly executing machine learning based on deep learning or the like using teacher data.

The object G includes, for example, other vehicles, pedestrians, objects, road structures, or the like existing around the vehicle 1, which affects the traveling of the vehicle 1. In the illustrated example, the object G is another vehicle. For example, the calculation unit 21 executes a calculation for simulating a virtual traveling state of the vehicle 1 including the positional relationship between the object G and the vehicle 1 within a time range from the current time (T) to a future time (T+Δt) that is advanced by a predetermined time (Δt).

For example, the calculation unit 21 calculates the first moving trajectory R1 of the vehicle 1 from the present time (T) to the future time (T+Δt) and calculates the relative positional relation between the vehicle 1 and the object. In case of the object G is a moving object, the calculation unit 21 calculates a second moving trajectory R2 of the object and calculates a change over time in the relative positional relation between the vehicle 1 and the moving object G. In case of the object G does not move, the calculation unit 21 calculates a change over time in the relative positional relationship between the vehicle 1 and the object G that does not move.

The calculation unit 21 calculates the future traveling state accompanied by a state change of the vehicle 1 within a future time range based on information related to the traveling of the vehicle 1, such as a change state of a traveling locus of the current vehicle 1, a change state of an operation content of the user, a change state of the environment around the vehicle 1 such as a signal, the travel plan of the vehicle 1, and the like. The calculation unit 21 calculates the future traveling state of the vehicle 1, such as acceleration, deceleration, stop, lane change of the vehicle 1, right and left turn, and U-turn, based on the information on the traveling of the vehicle 1.

The calculation unit 21 calculates the future traveling state accompanied by a change in the state of the object such as a lane change, a right and left turn, a path change of the object such as a U-turn, and the like within a future time range based on not only the vehicle 1 but also a change state of the traveling locus of the current object, a change state of the appearance such as a winker and a steering wheel, a change state of the environment around the vehicle 1 such as a signal, and the like. In a case where the information on the travel can be acquired from a communicable object such as another vehicle, the calculation unit 21 may calculate a future travel state accompanied by a change in the state of the object based on the information acquired from the other vehicle. The calculation unit 21 outputs the simulation result at predetermined time intervals.

The calculation unit 21 outputs a simulation result and determines the contact risk with a future object occurring in the vehicle. For example, the calculation unit 21 determines the contact risk between the vehicle 1 and the object based on the relative positional relationship between the vehicle 1 and the object in the calculation result. Based on the data such as the position information of the vehicle 1, the size of the vehicle 1, the attitude of the vehicle 1, the shape of the object G, and the size of the object G, the distance to the object is corrected, and the actual relative distance L between the vehicle 1 and the object G is calculated.

For example, the calculation unit 21 calculates a collision margin time (Time-To-Collision: TTC) as a criterion for determining the contact risk. The collision margin time is the remaining time required until the vehicle 1 and the object collide with each other in case of the vehicle 1 and the object maintain the current relative speed. The calculation unit 21 calculates TTC between the vehicle 1 and the object G based on the distance L and the relative velocity between the vehicle 1 and the object G.

The calculation unit 21 may calculate one or more first moving trajectory R1. The calculation unit 21 may calculate one or more second moving trajectory R2. The calculation unit 21 may calculate a plurality of TTC in a combination of one or more first movement trajectory R1 and one or more second movement trajectory R2. The calculation unit 21 may calculate a plurality of touch risks based on a plurality of TTC.

The calculation unit 21 sets the contact risk to be higher as TTC approaches a predetermined time that becomes a preset criterion. And the calculation unit 21 sets the contact risk to be lower as TTC moves away from the predetermined time that becomes a preset criterion. In case of TTC is equal to or less than a predetermined period that is a preset criterion, the calculation unit 21 determines that the contact-risk exceeds the predetermined criterion. The calculation unit 21 may use other calculation methods if it can calculate not only TTC but also the contact-risk between the vehicle 1 and the target object. In case of it is determined that the contact risk exceeds the predetermined criterion, the calculation unit 21 executes the driving assistance to the vehicle 1. The calculation unit 21 may calculate a plurality of contact risks and may execute driving assistance to the vehicle 1 in case of it is determined that the at least one contact risk exceeds the predetermined criterion.

In the driving assistance, the calculation unit 21 generates a notification indicating that the vehicle is approaching the target object within a predetermined distance in the future. The calculation unit 21 transmits the notification generated to the vehicle 1 via the network W and causes the notification unit 3 to output the notification content in cooperation with the control unit 11 of the vehicle 1. The control unit 11 causes the notification unit 3 to output the notification content in accordance with the notification mode. The control unit 11 generates notification content based on images, causes the display unit 3A to display the notification content based on sounds, and causes the speaker 3B to output the notification content. For example, in the driving assistance, the calculation unit 21 causes the vehicle 1 to output the notification indicating a path for reducing the contact risk.

In case of determining that the contact risk exceeds the predetermined criterion, the calculation unit 21 may cause the vehicle 1 to start the occupant protection control and the driving assistance. For example, the calculation unit 21 causes the vehicle 1 to perform deceleration control and/or steering control in cooperation with the control unit 11 to reduce the contact risk in the driving assistance. In case of determining that at least one contact risk among the plurality of contact risks exceeds the predetermined criterion, the calculation unit 21 may cause the vehicle 1 to output a notification for guiding the steering direction or a notification for causing acceleration/deceleration to reduce the contact risk. For example, the calculation unit 21 controls the driving unit 5, the braking unit 6, and the steering unit 7 in cooperation with the control unit 11 to decelerate, avoid, and stop the vehicle 1.

The calculation unit 21 may cause the vehicle 1 to start the occupant protection control and the driving assistance at a second timing earlier than the first timing at which the vehicle 1 starts the occupant protection control and the driving assistance by itself. Since the calculation unit 21 calculates the contact risk in advance based on the simulation result, it is possible to cause the vehicle 1 to start the occupant protection control and the driving assistance at the second timing earlier than the first timing on the vehicle 1 side.

In a case where the calculation unit 21 calculates a plurality of contact risks and determines that at least one contact risk exceeds the predetermined criterion, the calculation unit may calculate a plurality of driving assistance patterns and cause the vehicle 1 to start one driving assistance with the lowest contact risk. For example, the calculation unit 21 may calculate a plurality of avoidance paths in the driving support and cause the vehicle 1 to travel on one route with the lowest contact risk.

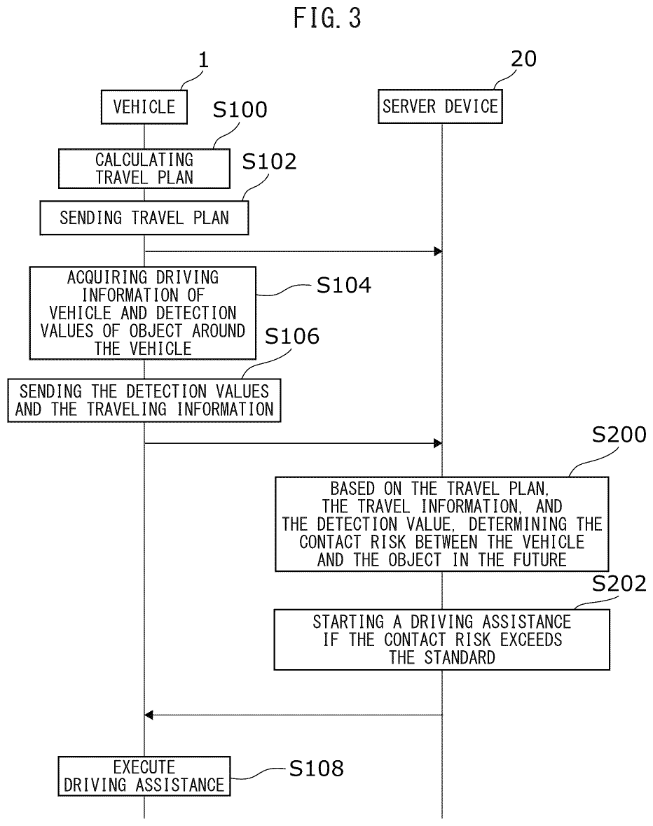

FIG. 3 shows a flow of processing of the vehicle control method executed in the vehicle system S. The vehicle control method is executed based on a first computer program installed in a computer installed in the server device 20. In the vehicle control method, the entire vehicle system S is processed in cooperation with the first computer program and the second computer program installed in the computer installed in the vehicle control device 10.

In the vehicle control device 10, the control unit 11 calculates a travel plan including a route to a destination based on an input-operation of the user (S100). The control unit 11 transmits the calculated travel plan to the server device 20 (S102). The control unit 11 acquires detection values of the object which is detected by the detection unit 2 and which is present around the vehicle, and which is related to the travel of the vehicle, and travel information related to the travel of the vehicle 1 (S104). The control unit 11 transmits the detection values 30 and the traveling information to the server device 20 (S106).

In the server device 20, the calculation unit 21 calculates the traveling state including a future positional relation between the object and the vehicle based on the travel plan, the detection value, and the traveling information, and determines the contact risk with a future object occurring in the vehicle (S200). In case of it is determined that the contact-risk exceeds the predetermined criterion, the calculation unit 21 executes the driving assistance to the vehicles (S202).

In the vehicle 1, the control unit 11 outputs the notification content to the notification unit 3, operates the occupant protecting device 8, and controls the driving unit 5, the braking unit 6, and the steering unit 7 to perform deceleration control and/or steering control on the vehicle 1 to reduce the contact-risk (S108).

As described above, according to the vehicle system S, the calculation of the determination result of the contact risk between the vehicle 1 and the object can be accelerated by executing the simulation regarding the future traveling state of the vehicle 1 object G in the server device 20. According to the vehicle system S, by determining the contact risk which occurs to the vehicle in the future with the object G, it is possible to start the driving assistance at a second timing earlier than the first timing at which the driving assistance or the like executed in the vehicle 1 is started.

According to the vehicle system S, it is possible to distribute the calculation load of the vehicle control device 10 on the vehicle 1 side by determining the contact risk in the future between the vehicle 1 and the object G in the server device 20. According to the vehicle system S, by calculating a plurality of contact risks, it is possible to execute the driving assistance corresponding to the traveling state of the vehicle 1 that changes from moment to moment.

In the above-described embodiment, the computer program executed in each configuration of the vehicle system S may be provided in a form recorded in a computer-readable portable recording medium such as a semiconductor memory, a magnetic recording medium, or an optical recording medium. The vehicle 1 may be a manual driving vehicle or an automatic driving vehicle. The vehicle system S may be applied to a manually driven vehicle or an automated driving vehicle. The computer program may be provided as a computer product.

1. A vehicle system comprising a server device communicably connected to a vehicle, the server device includes a processor for performing an operation related to the travel of the vehicle, wherein the processor is configured to perform the following processing:
calculating a traveling state including a future positional relationship between an object and the vehicle based on detection values of the object and traveling information which relates to traveling of the vehicle, wherein the object exists around the vehicle and relates to traveling of the vehicle;
based on the traveling state, determining a contact risk which occurs to the vehicle in the future with the object;
if the contact risk exceeds a predetermined criterion, executing driving assistance to the vehicle.

2. The vehicle system of claim 1, wherein the processor is configured to perform the following processing:
in the driving assistance, causing the vehicle to output a notification indicating that the vehicle is approaching the object within a predetermined distance in the future.

3. The vehicle system of claim 1, wherein the processor is configured to perform the following processing:
if the contact risk exceeds a predetermined criterion, causing the vehicle to start an occupant protection control and the driving assistance at a second timing earlier than a first timing at which the vehicle starts the occupant protection control and the driving assistance.

4. The vehicle system of claim 1, wherein the processor is configured to perform the following processing:
in the driving assistance, causing the vehicle to perform deceleration control and/or steering control to reduce the contact risk.

5. A non-transitory storage medium storing a program installed in a computer mounted on a vehicle system including a server device communicably connected to a vehicle, wherein the non-transitory storage medium causes the computer to perform the following processing for causing the computer to support driving of the vehicle:
acquiring detection values of an object and travel information related to the travel of the vehicle, wherein the object exists around the vehicle and relates to the travel of the vehicle;
calculating a driving state including a future positional relationship between the object and the vehicle based on the detection values and the traveling information;
based on the traveling state, determining a contact risk which occurs to the vehicle in the future with the object;
if the contact risk exceeds a predetermined criterion, executing driving assistance to the vehicle.
